(19) United States
(12) Patent Application Publication
(10) Pub. No.: US 2022/0383233 A1
(43) Pub. Date: Dec. 1, 2022

(54) WORK SUPPORT SYSTEM, WORK SUPPORT METHOD, AND WORK SUPPORT PROGRAM

(71) Applicant: MITSUBISHI HEAVY INDUSTRIES, LTD., Tokyo (JP)

(72) Inventors: Susumu SEKINE, Yokohama-shi (JP); Tadashi OTA, Yokohama-shi (JP); Satoru HIGUCHI, Yokohama-shi (JP); Junichi KUWAHARA, Yokohama-shi (JP); Ryosuke HORIUCHI, Yokohama-shi (JP); Yutaka KANO, Yokohama-shi (JP); Tomoyuki YAMAZAKI, Tokyo (JP)

(21) Appl. No.: 17/773,740

(22) PCT Filed: Nov. 4, 2020
(86) PCT No.: PCT/JP2020/041256

§ 371 Date: May 2, 2022

(30) Foreign Application Priority Data
Nov. 7, 2019 (JP) 2019-202186

(51) Int. Cl. G06Q 10/06; G06Q 10/00

(52) U.S. Cl. CPC G06Q 10/063116; G06Q 10/06316; G06Q 10/20

(57) ABSTRACT

A work support system gives work support by using a work schedule which is created by dividing support target work into a plurality of division tasks and distributing a worker unit. The present system includes an interruption information acquisition part for acquiring interruption information, and a work schedule modification part for modifying the work schedule if the interruption information is acquired. The work schedule is modified by redistributing, to the division task started after the interruption event, the remaining worker unit excluding the worker unit distributed to the division task in which the interruption event occurs.

### TECHNICAL FIELD

The present disclosure relates to a work support system, a work support method, and a work support program for giving work support.

### BACKGROUND

Maintenance work performed by a plurality of workers, such as regular inspection work for plant equipment, requires a huge amount of work to be done within a limited work period while ensuring work quality. In such maintenance work, the work quality is likely to be influenced by a skill level of a worker. In recent years, however, it has become difficult to secure a skilled worker. In addition, there are increasing demands for cost cuts due to longer maintenance periods (intervals) and shorter work periods, and it is required to meet these demands.

In order to meet these demands, it has been proposed to give work support by managing the schedule of the huge amount of work included in the maintenance work with arithmetic processing by an electronic computation device such as a computer. For example, Patent Document 1 discloses a system for giving work support such that each worker involved in maintenance work acquires information about work contents distributed to each worker at an appropriate timing, by displaying maintenance work procedure information indicating a maintenance work procedure on a terminal based on scheduled work schedule information.

### CITATION LIST

### Patent Literature

Patent Document 1: JP2003-233419A

### SUMMARY

### Technical Problem

Meanwhile, in the process of executing a work schedule related to the maintenance work as in Patent Document 1, an interruption event may occur in the work contents distributed to each worker. If the interruption event thus occurs in some works, it becomes difficult to perform another work that presupposes the concerned work (for example, work that belongs to a common critical path and is performed later in chronological order). In this case, the worker distributed to the another work has no choice but to wait until the work in which the interruption event occurs is restored, resulting in waste.

At least one embodiment of the present disclosure has been made in view of the above, and the purpose of the at least one embodiment of the present disclosure is to provide a work support system, a work support method, and a work support program capable of giving efficient work support even if the interruption event occurs in the middle of the work.

### Solution to Problem

A work support system according to at least one embodiment of the present disclosure is a work support system that gives work support by using a work schedule which is created by dividing at least one support target work into a plurality of division tasks with a unit work amount corresponding to a worker unit including a plurality of workers, and distributing the worker unit to each of the plurality of division tasks, the work support system including an interruption information acquisition part configured to acquire interruption information indicating that an interruption event occurs in any of the plurality of division tasks, and a work schedule modification part configured to modify the work schedule by redistributing, to the division task started after the interruption event, the remaining worker unit excluding the worker unit distributed to the division task in which the interruption event occurs, if the interruption information acquisition part acquires the interruption information.

A work support method according to at least one embodiment of the present disclosure is a work support method that gives work support by using a work schedule which is created by dividing at least one support target work into a plurality of division tasks with a unit work amount corresponding to a worker unit including a plurality of workers, and distributing the worker unit to each of the plurality of division tasks, the work support method including a step of acquiring, by an interruption information acquisition part, interruption information indicating that an interruption event occurs in any of the plurality of division tasks, and a step of modifying, by a work schedule modification part, the work schedule by redistributing, to the division task started after the interruption event, the remaining worker unit excluding the worker unit distributed to the division task in which the interruption event occurs, if the interruption information acquisition part acquires the interruption information.

A work support program according to at least one embodiment of the present disclosure causes, in order to give work support by using a work schedule which is created by dividing at least one support target work into a plurality of division tasks with a unit work amount corresponding to a worker unit including a plurality of workers, and distributing the worker unit to each of the plurality of division tasks, a computer to function as a means for acquiring interruption information indicating that an interruption event occurs in any of the plurality of division tasks, and a means for modifying the work schedule by redistributing, to the division task started after the interruption event, the remaining worker unit excluding the worker unit distributed to the division task in which the interruption event occurs, if the interruption information is acquired.

### Advantageous Effects

According to at least one embodiment of the present disclosure, it is possible to provide a work support system, a work support method, and a work support program capable of giving efficient work support even if an interruption event occurs in the middle of work.

### BRIEF DESCRIPTION OF DRAWINGS

FIG. 1 is a schematic diagram showing the overall configuration of a work support system according to an embodiment of the present disclosure.

FIG. 2 is a functional block diagram showing the internal configuration of a main server in FIG. 1, together with a surrounding configuration.

FIG. 3 is an organizational structure diagram corresponding to information about worker units stored in a worker unit database.

FIG. 4 is a schematic diagram showing a state in which unit leaders of the respective worker units are gathered and a Foreman F is transmitting an instruction.

FIG. 5A is a schematic diagram showing communication routes among three workers.

FIG. 5B is a schematic diagram showing communication routes among four workers.

FIG. 6 is a Gantt chart showing an example of a work schedule created by a work schedule creation part.

FIG. 7 is a flowchart showing steps of work schedule modification control.

FIG. 8 is a Gantt chart showing a modified work schedule.

FIG. 9 is a view showing an example of displaying work support information by a user terminal.

FIG. 10 is a view showing an example of displaying the work support information by the user terminal.

FIG. 11 is an explanatory view of pipe assembly work.

FIG. 12 is a schematic view showing a tool used in the work and a storage shelf in which the tool is stored.

FIG. 13 is a schematic top view schematically showing the arrangement of the storage shelves in FIG. 12.

### DETAILED DESCRIPTION

Embodiments of the present invention will now be described with reference to the accompanying drawings. It is intended, however, that unless particularly specified, dimensions, materials, shapes, relative positions and the like of components described in the embodiments shall be interpreted as illustrative only and not intended to limit the scope of the present invention unless particularly specified.

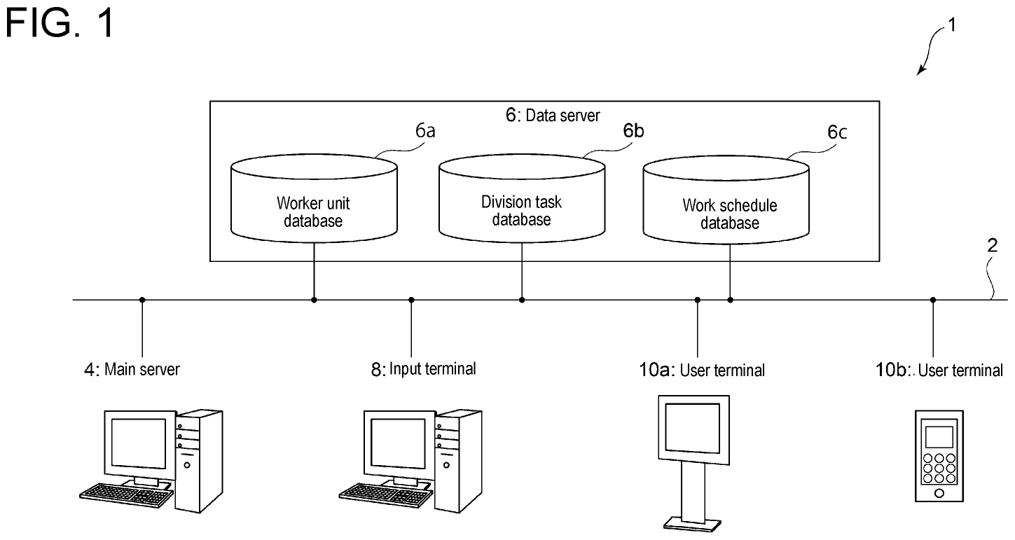

FIG. 1 is a schematic diagram showing the overall configuration of a work support system 1 according to an embodiment of the present disclosure. The work support system 1 is a system that gives work support by providing work support information to a plurality of workers who are, respectively, implementing entities of support target work. In the following description, maintenance work related to plant equipment (more specifically, regular inspection work of plant equipment such as a nuclear power plant, a thermal power plant or a chemical plant) will be described as support target work. However, the contents of the support target work can be optional.

As shown in FIG. 1, the work support system 1 includes a main server 4, a data server 6, an input terminal 8, and user terminals 10a and 10b connected to each other by a communication network 2. The communication network 2 is a network capable of transmitting and receiving various types of data among the components of the work support system 1, and may be wired or wireless.

The main server 4 is a server for performing main information processing in the work support system 1. The main server 4 creates work support information by performing predetermined information processing with information acquired from the data server 6, the input terminal 8, and the user terminals 10a and 10b, and provides the work support information to the user terminals 10a and 10b, thereby giving work support to a worker using the user terminals 10a and 10b.

The data server 6 is a server that includes a database for storing various types of data related to an operation of the work support system 1. The data server 6 is configured to store and read various types of information by being accessed from other system components via the communication network 2. The data server 6 includes a plurality of databases corresponding to the respective types of information, and FIG. 1 shows a worker unit database 6a, a division task database 6b, and a work schedule database 6c. Each database constituting the data server 6 will be described in detail later.

The input terminal 8 is an input interface for inputting the various types of information about the operation of the work support system 1. The input terminal 8 may be a human interface that can manually be input by an operator such as the worker, or may be an inter-device interface that can input data from another information processing device.

The user terminals 10a and 10b are, respectively, devices that can be used by the worker who is the implementing entity of the support target work. The work support information created by the main server 4 is output to the user terminals 10a and 10b to allow the worker to use the work support information. In the present embodiment, it is configured such that the work support information is displayed on the respective displays of the user terminals 10a and 10b to be used by the worker. However, an output form of the work support information on the user terminals 10a and 10b is not limited to the above configuration. In addition to outputting the work support information, the user terminals 10a and 10b may be configured to allow the worker to view a calculation result of the main server 4 and the various types of information stored in the data server 6 as needed.

The user terminals 10a and 10b may be configured to function not only as a means for providing the work support information and the like to the worker but also as an input interface for the worker to input various types of information to the work support system 1 as needed. In this case, the information input from the user terminals 10a and 10b may be processed by the user terminals 10a and 10b themselves, or may be sent to the main server 4 to be processed or may be stored in the data server 6 via the communication network 2.

FIG. 1 shows, as an example of a user terminal, the user terminal 10a as a stationary terminal fixedly installed at a specific point and the user terminal 10b as a portable terminal that can be carried by an individual worker. The user terminal 10a is the stationary terminal fixed at the specific point, such as a large display, and can provide the work support information to a plurality of workers who can access the terminal. On the other hand, the user terminal 10b is the portable terminal that can be carried by the individual worker, such as a smartphone, a tablet, or a notebook computer, and can mainly provide the work support information to the individual worker.

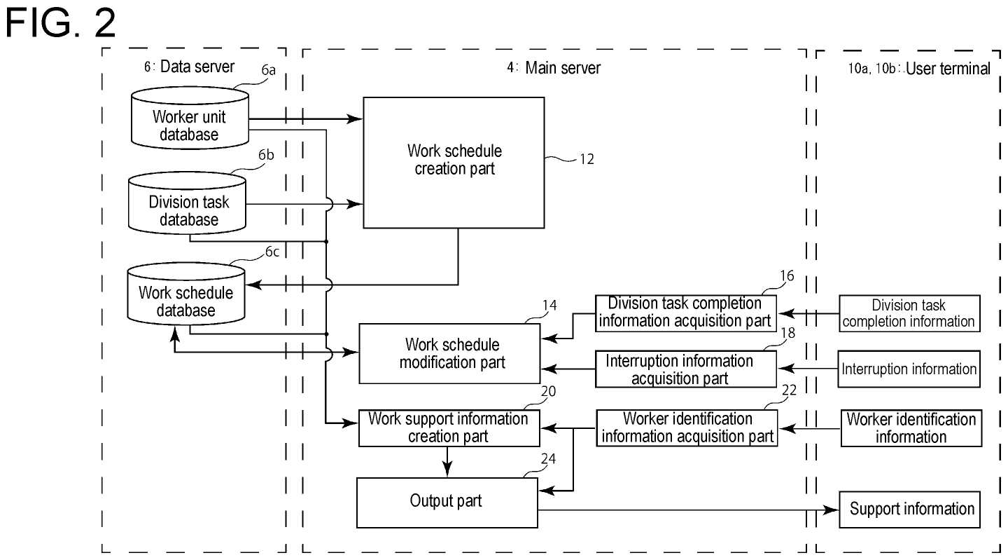

FIG. 2 is a functional block diagram showing the internal configuration of the main server 4 in FIG. 1, together with a surrounding configuration. FIG. 2 shows, together with the main server 4, the configurations of the data server 6 and the user terminal 10a or 10b, which are highly related to each block of the main server 4, as functional blocks (for the sake of clarity, other configurations including the communication network 2 are omitted as appropriate).

The main server 4 has a hardware configuration constituted by an electronic computation device such as a computer, and is configured by installing a work support program according to at least one embodiment of the present disclosure on the hardware configuration. Thus, the main server 4 can perform the work support method according to at least one embodiment of the present disclosure. The main server 4 includes a work schedule creation part 12, a work schedule modification part 14, a division task completion information acquisition part 16, an interruption information acquisition part 18, a work support information creation part 20, a worker identification information acquisition part 22, and an output part 24. The respective blocks constituting the main server 4 may be integrated or further divided.

The work schedule creation part 12 creates a work schedule WS based on the various types of information stored in the data server 6. More specifically, the work schedule creation part 12 acquires information about a worker unit from the worker unit database 6a and information about the division task from the division task database 6b, and creates the work schedule WS based on these pieces of information.

The worker unit database 6a stores information about the worker unit composed of the workers who are, respectively, the implementing entities of the support target work. The worker unit includes the number of workers each corresponding to a unit work amount of each division task obtained by dividing the support target work. In the present embodiment, the number of worker units involved in the support target work and the number of workers included in each worker unit are optimized, making it possible to contribute to ensuring work quality and shortening a work period.

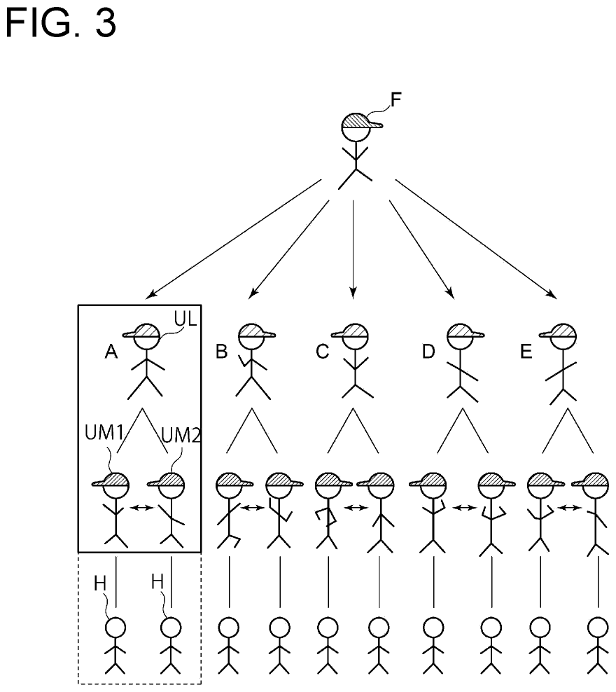

FIG. 3 is an organizational structure diagram corresponding to the information about worker units stored in the worker unit database 6a. In the organizational structure diagram, a Foreman F (Foreman) who comprehensively supervises the entire support target work is at the top of the organizational structure, and a plurality of worker units U are placed under the supervision of the Foreman F.

The number of worker units U under the supervision of one Foreman F may be set optionally. In the present embodiment, a case where five worker units A to E are placed is exemplified for the reasons to be described below. Depending on the scale of the support target work, the organizational structure may be made such that a plurality of Foremen F are placed and the plurality of worker units U are placed under the supervision of the respective Foremen F.

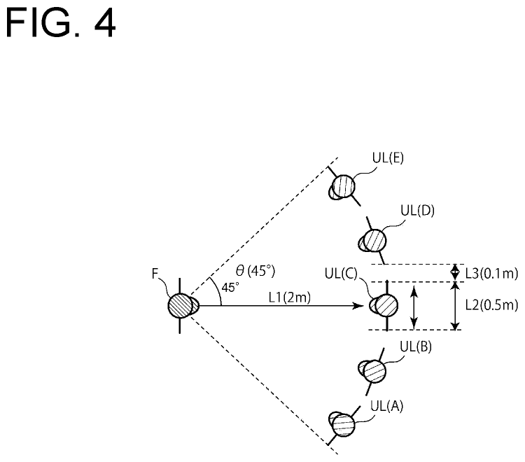

FIG. 4 is a schematic diagram showing a state in which unit leaders UL(A) to UL(E) of the respective worker units A to E are gathered and the Foreman F is transmitting an instruction. In this diagram, the unit leaders UL(A) to UL(E) of the respective worker units A to E are arranged in an arc shape centering on the Foreman F, as an efficient form in transmitting the instruction. Herein, assuming that a distance L1 between the Foreman F and each of the unit leaders UL(A) to UL(E) is 2 m which is an appropriate distance for clear communication between humans, a field of view θ of the Foreman F is 45 degrees to the left and right, an area width L2 occupied by each of the unit leaders UL(A) to UL(E) is 0.5 m, and an interval L3 between the unit leaders UL(A) to UL(E) is 0.1 m, as shown in FIG. 4, it is derived that the optimum number of the worker units U is “5”.

Returning to FIG. 3, each of the worker units A to E includes one unit leader UL, and two unit members UM1 and UM2. The unit leader UL is a senior worker in the worker unit, and executes the work covered by the worker unit by receiving the instruction from the Foreman F as described above and further instructing the two unit members UM1, UM2. The unit members UM1 and UM2 are general workers who work in response to the instruction from the unit leader UL. The unit leader UL and the unit members UM1, UM are workers who communicate with each other upon executing the work.

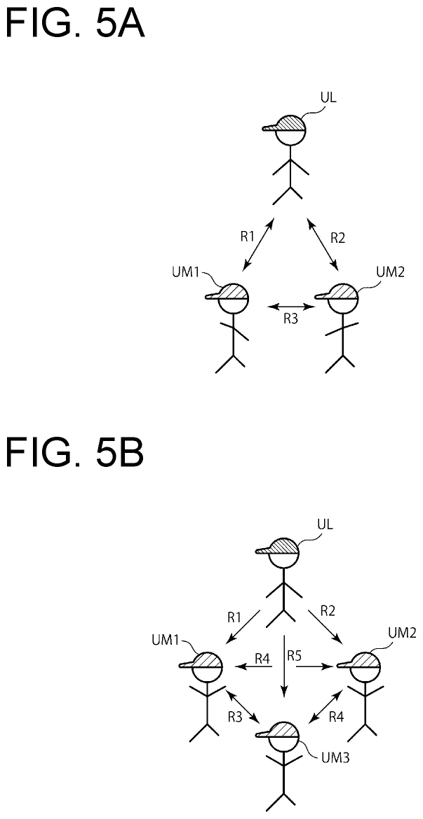

In the present embodiment, the number of workers who communicate with each other upon executing the work in each worker unit as described above is set to “3” based on the reason to be described below, thereby building a good communication system in which occurrence of miscommunication is prevented. FIG. 5A is a schematic diagram showing communication routes among three workers, and FIG. 5B is a schematic diagram showing communication routes among four workers.

As shown in FIG. 5A, in a worker unit composed of three workers, there are three patterns of communication routes R1 to R3. R1 is the communication route formed between the unit leader UL and the one unit member UM1, R2 is the communication route formed between the unit leader UL and the other unit member UM2, and R3 is the communication route formed between the one unit member UM1 and the other unit member UM2. On the other hand, as shown in FIG. 5B, if there are four workers (the one unit leader UL and three unit members UM1, UM2, UM3) in the worker unit, the number of communication routes that can be formed between the workers increases (in FIG. 5B, communications R1 to R5 exist), making good communication in the worker unit difficult. For the above reason, the number of workers constituting the worker unit is preferably set to “3”.

In addition to the above-mentioned three workers (the unit leader UL and the unit members UM1, UM2), the worker unit may include a helper H that can devotedly act for these workers. The helper H has the role of acting according to one-sided instruction from the workers and unlike the above-mentioned three workers, does not require mutual communication upon executing the work. In the example of FIG. 3, the one helper H is placed for each of the two unit members UM (two helpers in total). Thus, the two unit members UM can be assisted in the work by instructing the respective helpers H when performing the work. Since the helper H acts solely based on the instruction given by each unit member UM, the helper H does not contribute to the communication between the workers even if added to the worker unit U, making it possible to improve work efficiency without complicating the communication routes.

At a work site, the work is performed with the unit leader UL, the unit members UM1, UM2, and the helpers H, who hierarchically constitute the worker unit, being mixed. Thus, at the work site, each person may wear bibs for level discrimination so that each hierarchy (level) can be discriminated. As the bibs, it is possible to use a visually clear object, such as an object which is color coded according to the level.

Such information about the worker unit may artificially be created in advance or may be created by computer calculation. In the latter case, the information can be created by inputting a basic worker list to the computation device unit such as a computer and classifying the workers into each worker unit based on predetermined conditions. Then, the information about these worker units may be stored in the worker unit database 6a and prepared in advance, or may be input by using the input terminal 8.

Subsequently, the division task database 6b stores information about the division task created by dividing the support target work. The division task is created by dividing the support target work so as to correspond to the unit work amount of the worker unit. The information about the division task includes a plurality of division tasks thus created and relation information between the plurality of division tasks. The former is information about specific work contents in each division task, and includes, for example, information about work procedures, a caution in each work procedure, and a tool used in each work procedure. Further, the latter is information about the relative relationship between the respective division tasks, and includes, for example, information about a master-slave relationship and a critical path between the respective division tasks.

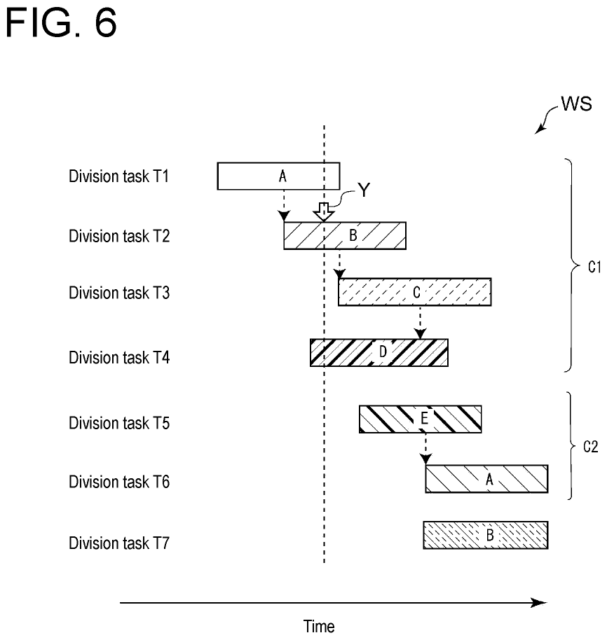

The work schedule creation part 12 creates the work schedule WS based on the information about the worker unit and the information about the division task described above. FIG. 6 is a Gantt chart showing an example of the work schedule WS created by the work schedule creation part 12. FIG. 6 shows the work schedule WS in which a certain support target work is divided into a plurality of division tasks T1, T2, . . . each having the unit work amount and the worker units A to E are respectively distributed to the division tasks T1, T2, . . . (although FIG. 6 only shows the division tasks T1 to T7, a division task T8 and beyond also exist).

These series of division tasks T1, T2, . . . are specified based on the information about the division task. More specifically, the master-slave relationship and the critical path of the respective division tasks T1, T2, . . . are defined based on the above-mentioned relation information. In FIG. 6, as indicated by dashed arrows, the division tasks T1 to T4 are included in a first critical path C1, and the division tasks T5 and T6 are included in a second critical path C2 (the first critical path C1 and the second critical path C2 are independent of each other).

The plurality of worker units A to E are distributed to the division tasks T1, T2, . . . . The worker units A to E are equivalent to each other, and are distributed to the division tasks T1, T2, . . . in order according to a priority set in advance. The priority set for each of the division tasks T1, T2, . . . may be stored in the division task database 6b in advance, for example.

The work schedule WS is thus created by distributing the plurality of worker units A to E to the plurality of division tasks T1, T2, . . . . Then, the work schedule WS created by the work schedule creation part 12 is stored in the work schedule database 6c of the data server 6 via the communication network 2, for example.

In the present embodiment, one support target work is basically handled. However, if a plurality of support target works are handled, a plurality of work schedules WS may also be created to correspond to the plurality of support target works, respectively. In this case, the information about the division task and the information about the worker unit included in the data server 6 are also managed in association with each support target work.

The work schedule modification part 14 is configured to modify the work schedule WS. For example, the work schedule modification part 14 accesses the work schedule database 6c triggered by an input of a predetermined signal, and modifies the work schedule WS stored in the work schedule database 6c. In the present embodiment, the work schedule WS is modified if the division task completion information acquisition part 16 acquires division task completion information or the interruption information acquisition part 18 acquires interruption information.

The division task completion information acquisition part 16 acquires the division task completion information. If any one of the plurality of division tasks T1, T2, . . . is completed, the division task completion information is input to the main server 4 as a signal indicating the above-described completion. For example, if the specific division task is completed, the division task completion information is created by operating the user terminal 10a or 10b, and is input to the main server 4 via the communication network 2. Then, the work schedule modification part 14 modifies the work schedule WS by redistributing the worker unit to the remaining division task excluding the division task specified from the division task completion information. Thus, the work schedule WS is updated every time each division task is completed, allowing for efficient work schedule management according to the progress of the work.

The division task completion information may include work history information about the completed division task. In this case, the work history information is saved as a work history in the data server 6 to be used for work evaluation and the like.

If an interruption event Y occurs in any one of the plurality of division tasks T1, T2, . . . , the interruption information acquisition part 18 is input to the main server 4 as a signal indicating the above-described occurrence. The interruption event Y broadly includes the reason why the worker unit has no choice but to interrupt execution of the division task when executing the division task, and means, for example, an event which is difficult to be completed within a work time assumed in advance for completing the division task. To give a specific example, in a case where a division task includes the process of removing a bolt securing a certain part in order to inspect the part, if the bolt is stuck and thus is difficult to be removed by normal procedures, this corresponds to the interruption event Y.

For example, such interruption information is created by operating the user terminal 10a or 10b by the worker in the occurrence of the interruption event Y, and is sent to the main server 4 via the communication network 2, thereby being acquired by the interruption information acquisition part 18.

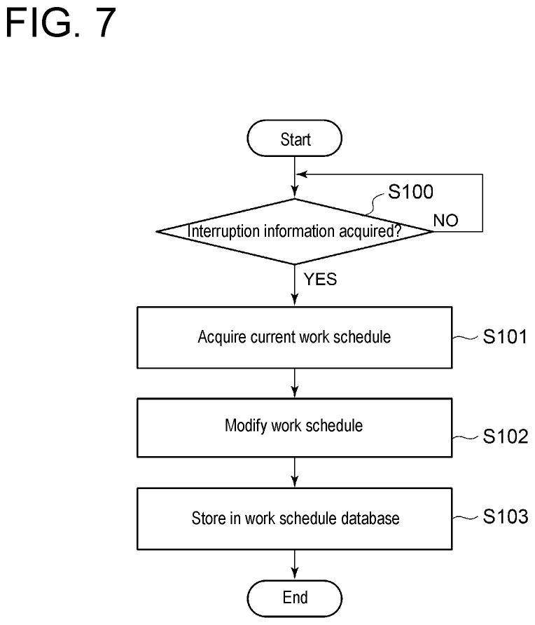

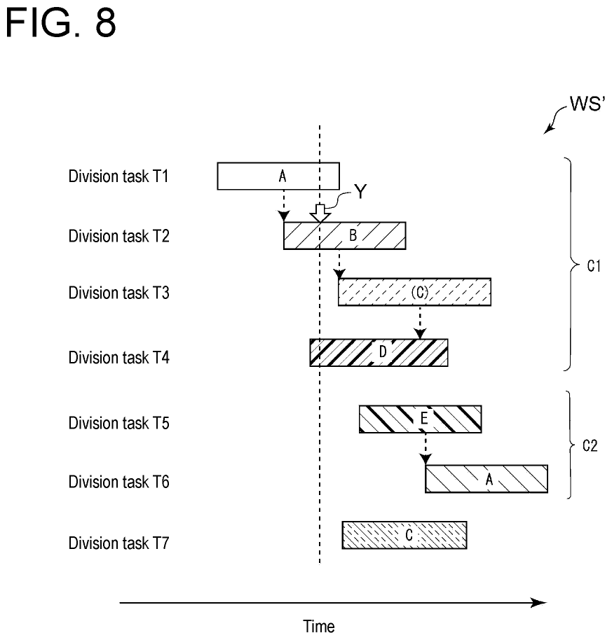

With reference to FIG. 7, modification control of the work schedule WS in the case where the interruption information is acquired will be described in detail. FIG. 7 is a flowchart showing steps of modification control of the work schedule WS. FIG. 8 is a Gantt chart showing a modified work schedule WS′ (that is, a modification example of the work schedule WS′ shown in FIG. 6).

First, the work schedule modification part 14 determines whether the interruption information acquisition part 18 acquires the interruption information (step S100). By repeatedly performing the determination in step S100, the occurrence of the interruption event Y is monitored. In the present embodiment, as shown in FIG. 6, the case where the interruption event Y occurs in the middle of the division task T2 will be described as an example. In this example, since the division task T2 in which the interruption event Y occurs is included in the first critical path C1, the subsequent division task T3 cannot be started until the interruption event Y is resolved, and the worker unit C distributed to the division task T3 has to wait until the interruption event is resolved. Such situation means that some worker units wait in vain, which is not efficient from the viewpoint of utilizing human resources. Thus, the work schedule modification part 14 modifies the work schedule WS in case the interruption event occurs, thereby improving efficiency.

If the interruption information acquisition part 18 acquires the interruption information (step S100: YES), the work schedule modification part 14 accesses the work schedule database 6c of the data server 6 and acquires the current work schedule WS (see FIG. 6) (step S101).

Subsequently, the work schedule modification part 14 modifies the work schedule WS by redistributing the worker unit to the division task started after the interruption event (step S102). The modification of the work schedule WS in step S102 is performed by redistributing, to the division task started after the interruption event, the remaining worker unit excluding the worker unit distributed to the division task in which the interruption event occurs. In the example of FIG. 8, since the interruption event Y occurs in the division task T2, the work schedule WS is modified by redistributing the another worker unit C excluding the worker unit B to the division task T7 started after the division task T2.

In the modified work schedule WS' shown in FIG. 8, while the worker unit B distributed to the division task T2 in which the interruption event Y occurs continues working in the division task T2 to resolve the interruption event Y, and the worker unit C is newly distributed to the division task T7 to which the worker unit B has been distributed after the second time in the work schedule WS before the modification. Thus, even if the interruption event Y occurs in some of the division tasks, it is possible to construct the work schedule WS that efficiently utilizes the worker unit distributed to another division task.

Alternatively, the modification of the work schedule WS in step S102 may be performed by distributing the worker unit, which is distributed to the division task included in the critical path to which the division task where the interruption event Y occurs belongs and started after the interruption event, to the division task which is included in the critical path different from the critical path of the division task where the interruption event Y occurs and is started after the interruption event. In the example of FIG. 8, since the interruption event Y occurs in the division task T2 included in the first critical path C1, the worker unit C, which is distributed to the division task T3 included in the first critical path C1 to which the division task T2 where the interruption event Y occurs belongs and started after the interruption event Y, is distributed to the division task T7 which is included in the second critical path D2 different from the first critical path C1.

In the work schedule WS before the modification shown in FIG. 6, since the worker unit C is distributed to the division task T3 started after the division task T2 in which the interruption event Y occurs in the first critical path C1, the worker unit C has to wait until the interruption event Y is resolved in the work schedule WS before the modification. On the other hand, in the modified work schedule WS′ shown in FIG. 8, the worker unit C distributed to the division task T3 is redistributed to the division task T7 belonging to the different critical path, making it possible to effectively use the waiting time of the worker unit C. Thus redistributing the worker unit C, which has been distributed to the division task T3 affected by the interruption event Y, to the division task T7 which is not affected by the interruption event Y, it is possible to construct the work schedule capable of efficiently utilizing the human resources.

The division task to which the worker unit is redistributed may be executed ahead of schedule according to the time allowance of the worker unit. In the example of FIG. 8, the division task T7 to which the worker unit C is redistributed is modified to be executed at an earlier timing than the work schedule WS before the modification shown in FIG. 6.

Subsequently, the work schedule modification part 14 stores the modified work schedule WS′ in the work schedule database 6c (step S103). Thus, the work schedule WS stored in the work schedule database 6c is updated to the latest state.

If the work support system 1 handles the plurality of support target works as described above, the work schedule modification part 14 may modify the plurality of work schedules respectively corresponding to the support target works. In this case, the worker unit may be redistributed to the division task over a plurality of work schedules. Thus, if the interruption event occurs in any of the division tasks, each work schedule is modified by redistributing the worker unit to the division task in each work schedule, making it possible to utilize the human resources more effectively.

Returning to FIG. 2 again, the work support information creation part 20 creates the work support information based on data stored in the data server 6. The work support information includes, for example, information about at least one of the tools used in the division tasks T1, T2, . . . , the worker unit, and the work caution. Such creation of the work support information by the work support information creation part 20 may automatically be performed, or may be performed in response to requests from the user terminals 10a and 10b used by the worker.

The work support information creation part 20 may create useful work support information for the worker who is specified based on the worker identification information acquired by the worker identification information acquisition part 22. The worker identification information acquisition part 22 acquires the worker identification information for identifying the worker. For example, each worker owns a worker identification device capable of outputting the worker identification information for specifying an individual, and the worker identification information acquisition part 22 acquires, via the communication network 2, the worker identification information output from the device. As the worker identification device, it is possible to use, for example, an ID card owned by each worker and having an RFID tag capable of transmitting the worker identification information, a barcode capable of reading the worker identification information, or the like. The user terminal 10a or 10b acquires the worker identification information from these devices and sends the acquired worker identification information to the main server 4 via the communication network 2.

The work support information creation part 20 specifies, based on the thus acquired worker identification information, the worker who is the destination of the work support information, and creates the work support information for the specified worker. Thus, it is possible to provide the work support information customized for each worker. Further, the worker may be able to refer to work support information for other workers and the various types of information stored in the data server 6 via the user terminals 10a and 10b, by operating the user terminals 10a and 10b.

The output part 24 outputs the work support information created by the work support information creation part 20 to the user terminals 10a and 10b. Thus, based on the work schedule WS stored in the work schedule database 6c, the work support information about each division task is output to each worker.

The output part 24 may output the work support information on the condition that the worker identification information acquisition part detects the specific worker identification information. For example, the work support information for the worker unit A is output on the condition that the worker identification information corresponding to each worker constituting the worker unit A is acquired. Thus, since the work support information is output after recognizing the worker to whom the work support information is provided, the situation where the worker misses the work support information is systematically avoided, making it possible to effectively improve work quality.

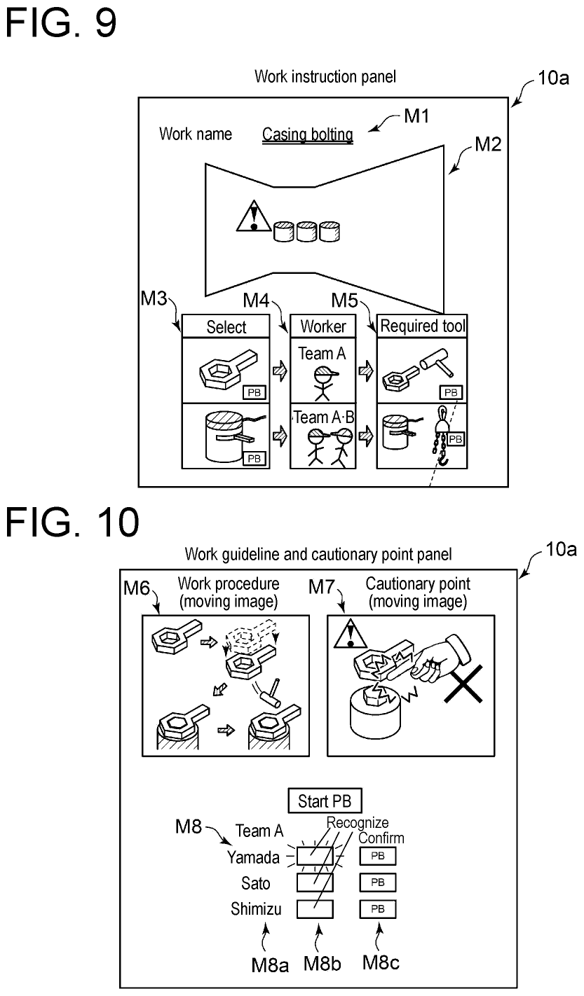

Next, some specific examples of the work support information will be described. FIGS. 9 and 10 are each a view showing an example of displaying the work support information by the user terminal 10a. As described above, the user terminal 10a is the stationary terminal intended for use by the plurality of workers at the work site, and includes a display for displaying the work support information.

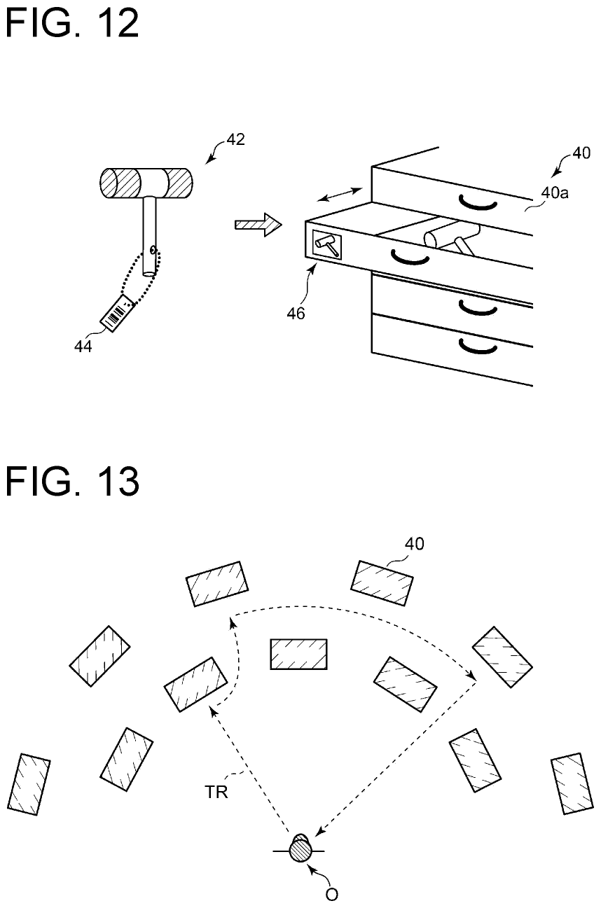

In the example of FIG. 9, a work name M1, a work object M2, tools or jigs M3 required for the work name M1 (push buttons PB to select these are also displayed), and a display M4 for selecting/confirming the worker involved in the work name M1, involuntary tools M5 required to perform work name M1 (the push buttons PB to transfer to a system (see FIG. 13) to get the tools M5 are also displayed) are displayed on the display of the user terminal 10a.

Further, in the example of FIG. 10, as the work support information, a work procedure M6, a cautionary point M7, and a worker recognition screen M8 are displayed on the display of the user terminal 10a. The work procedure M6 and the cautionary point M7, respectively, display the specific procedure in the division task included in the work support information and the cautionary point in executing each work procedure, in the format of, for example, moving images. Thus, it is possible to easily obtain the understanding necessary for executing the division task, regardless of the skill level of the worker.

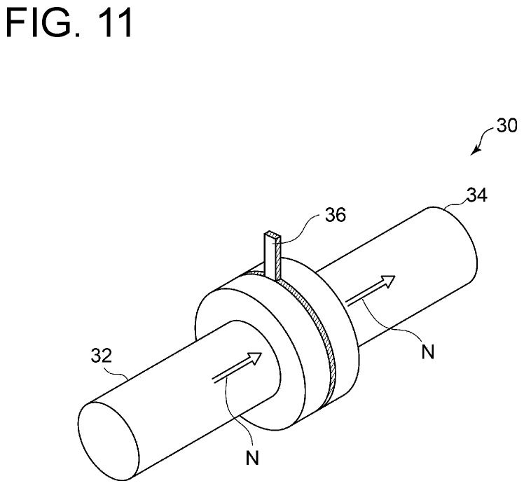

The specific example of the cautionary point M7 included in the work support information will now be described. Herein, as an example of the division task, assembly work of a pipe 30 inside of which a fluid flows in a given direction will be described. As shown in FIG. 11, the pipe 30 includes a pair of pipe members 32, 34 which are arranged such that flange portions disposed at respective ends of the pipe members 32, 34 face each other, and an orifice 36 interposed between the pair of pipe members 32 and 34. The orifice 36 is installed so as to correspond to a direction N of the fluid flowing inside the pipe 30. Thus, when assembling the pipe 30, the worker needs to grasp the direction N of the fluid flowing inside the pipe 30 and to embed the orifice 36 in the accurate direction.

Therefore, the work support information displays, as the cautionary point M7, the direction N of the fluid in the pipe 30 which is the work target on the display of the user terminal 10b. Thus, the worker can easily and accurately grasp the direction N of the fluid in the pipe 30 by checking the display, and it is possible to effectively prevent a work mistake such as the wrong direction of the orifice 36.

Returning to FIG. 10 again, the worker recognition screen M8 displays worker names M8a, indicators M8b each indicating the worker recognition, and confirmation buttons M8c. As described above, each indicator M8b lights up depending on whether the user terminal 10a detects the worker identification information corresponding to a corresponding one of the worker names M8a. Each confirmation button M8c is a button for enabling touch operation if a corresponding one of the indicators M8b lights up, and for completing worker authentication by the touch operation. In FIG. 10, the indicators M8b and the confirmation buttons M8c respectively corresponding to the three workers are provided on the worker recognition screen M8, and the details of the work support information are displayed on the condition that all the three workers are authenticated. Thus, the work support information is displayed after confirming that all the workers involved in the division task are available, allowing for accurate work support.

The work support information may also include information about the tool used in the division task. FIG. 12 is a schematic view showing a tool used in the work and a storage shelf 40 in which the tool is stored. FIG. 13 is a schematic top view schematically showing the arrangement of the storage shelves 40 in FIG. 12. Each storage shelf 40 includes a plurality of shelves 40a, and each shelf 40a stores a tool 42. Each tool 42 is provided with a barcode tag 44 containing tool identification information, and it is possible to acquire the tool identification information by, for example, reading the barcode tag 44 with the user terminal 10b which is the portable terminal. The tool identification information is used, for example, to collate whether the tool should be used in each work, by collating with the information about the tool stored in the data server 6 in advance.

Each shelf 40a of the storage shelf 40 may be provided with a display 46 such as a photograph or a name of the tool 42 on the surface of each shelf 40a so that the stored tool 42 can be determined.

As shown in FIG. 13, a plurality of storage shelves 40 each in which the tool 42 is thus stored may be disposed in a fan shape with a reference position O as the center. Thus, the worker can efficiently access each storage shelf 40 with the reference position O as a starting point.

Further, which tool 42 is stored in which storage shelf 40 may be determined according to the frequency of use and the weight of each tool 42. For example, the frequently used tool 42 and the tool 42 which is heavy and requires a large amount of labor for transportation may be stored in the storage shelf 40 located near the reference position O of the worker.

Further, as a device for outputting the tool identification information from each tool 42, an RFID tag capable of transmitting a signal related to the tool identification information may be used. In this case, by attaching the RFID tag to each tool 42 and acquiring the tool identification information transmitted from each tool 42, which tool 42 is stored in which storage shelf 40 may be managed. Furthermore, based on the storage state of the tool 42 in each storage shelf 40, a tool collection route TR for efficiently collecting each tool 42 required in each division task T1, T2, . . . to which the worker unit is distributed may be included in the work support information. FIG. 13 exemplifies the tool collection route TR capable of patrolling, by the shortest route, several storage shelves 40 each in which the tool 42 required for a certain division task is stored. Thus, the tools can be collected with less effort, allowing for the work support for effectively using limited human resources.

As described above, according to the above-described embodiments, it is possible to provide the work support system, the work support method, and the work support program capable of giving efficient work support by effectively utilizing the limited resources even if the interruption event occurs in the middle of execution of the work.

As for the rest, without departing from the spirit of the present disclosure, it is possible to replace the constituent elements in the above-described embodiments with known constituent elements, respectively, as needed and further, the above-described embodiments may be combined as needed.

The contents described in the above embodiments would be understood as follows, for instance.

(1) A work support system (1) according to an embodiment of the present disclosure is a work support system that gives work support by using a work schedule (such as the work schedule WS of the above-described embodiment) which is created by dividing at least one support target work into a plurality of division tasks (such as the division tasks T1, T2, . . . of the above-described embodiment) with a unit work amount corresponding to a worker unit (such as the worker units A to E of the above-described embodiment) including a plurality of workers, and distributing the worker unit to each of the plurality of division tasks, the work support system including an interruption information acquisition part (such as the interruption information acquisition part 18 of the above-described embodiment) configured to acquire interruption information indicating that an interruption event (such as the interruption event Y of the above-described embodiment) occurs in any of the plurality of division tasks, and a work schedule modification part (such as the work schedule modification part 14 of the above-described embodiment) configured to modify the work schedule by redistributing, to the division task started after the interruption event, the remaining worker unit excluding the worker unit distributed to the division task in which the interruption event occurs, if the interruption information acquisition part acquires the interruption information.

With the above configuration (1), the work schedule is created by dividing the support target work into the plurality of division tasks having the unit work amount and distributing the worker unit to each of the plurality of division tasks. In such work schedule, if the interruption event occurs in any of the division tasks, the work schedule is modified by redistributing, to the division task started after the interruption event, the remaining worker unit excluding the worker unit distributed to the division task in which the interruption event occurs. Thus, even if the interruption event occurs in some of the division tasks, it is possible to construct the work schedule that efficiently utilizes the worker unit distributed to another division task.

(2) In some embodiments, in the above configuration (1), the work schedule modification part modifies the work schedule to distribute the worker unit, which is distributed to the division task included in a critical path to which the division task where the interruption event occurs belongs and started after the interruption event, to the division task which is included in a critical path different from the critical path of the division task where the interruption event occurs and is started after the interruption event.

With the above configuration (2), the worker unit distributed to the division task which is difficult to start due to the occurrence of the interruption event is redistributed to the division task belonging to the critical path different from the critical path of the division task in which the interruption event occurs. Thus, it is possible to assign the worker unit which may have wasted waiting time due to the occurrence of the interruption event to the division task which is not affected by the interruption event, and to reconstruct the work schedule capable of efficiently utilizing the human resources.

(3) In some embodiments, in the above configuration (1) or (2), the support work system further includes a division task completion information acquisition part (such as the division task completion information acquisition part 16 of the above-described embodiment) for acquiring division task completion information indicating that any of the plurality of division tasks is completed. The work schedule modification part is configured to modify the work schedule by redistributing the worker unit to the remaining division task, if the division task completion information acquisition part acquires the division task completion information.

With the above configuration (3), if some of the division tasks are completed, the worker unit is redistributed to the uncompleted division task. Thus, the work schedule is updated every time each division task is completed, allowing for efficient work schedule management according to the progress of the work.

(4) In some embodiments, in any one of the above configurations (1) to (3), the at least one support target work includes a plurality of support target works independent of each other, and the work schedule modification part is configured to modify a plurality of work schedules corresponding to the plurality of support target works, respectively.

With the above configuration (4), if there are the plurality of support target works, the work schedule is created for each support target work by distributing the worker unit to the division task obtained by dividing the plurality of support target works. Then, if the interruption event occurs in any of the division tasks, each work schedule is modified by redistributing the worker unit to the division task in each work schedule, making it possible to utilize the human resources more effectively.

(5) In some embodiments, in any one of the above configurations (1) to (4), the support work system further includes an output part (such as the output part 24 of the above-described embodiment) configured to output work support information about the division task based on the work schedule.

With the above configuration (5), since the work support information based on the work schedule is output, it is possible to give efficient work support to each worker performing the work in accordance with the work schedule.

(6) In some embodiments, in the above configuration (5), the work support information includes information about at least one of a tool used in the division task, the worker unit, and a work caution.

With the above configuration (6), since the above information is included in the work support information, it is possible to give effective work support.

(7) In some embodiments, in the above configuration (6), the division task includes installation work for an orifice (such as the orifice 36 of the above-described embodiment) which is disposed between a pair of pipe members (such as the pipe members 32, 34 of the above-described embodiment) in correspondence with a direction of a fluid (such as the direction N of the fluid of the above-described embodiment) flowing inside the pair of pipe members, and the work caution includes information about an installation direction of the orifice.

With the above configuration (7), since the work caution included in the work support information includes the information about the installation direction of the orifice, it is possible to effectively prevent the worker from mistaking the installation direction of the orifice in the orifice installation work.

(8) In some embodiments, in any one of the above configurations (5) to (7), the support work system further includes a worker identification information acquisition part (such as the worker identification information acquisition part 22 of the above-described embodiment) configured to acquire worker identification information for identifying the worker. The output part is configured to output the work support information, if the worker identification information acquisition part acquires the worker identification information, which corresponds to the work support information, corresponding to the worker unit.

With the above configuration (8), the work support information is output on the condition that the worker identification information corresponding to the specific worker is acquired. Thus, it is possible to accurately provide the work support information to the specific worker, making it possible to give higher-quality work support.

(9) In some embodiments, in any one of the above configurations (5) to (8), the information about the used tool includes information about a shortest route (TR) passing through a plurality of storage shelves (such as the storage shelves 40 of the above-described embodiment) in which a plurality of tools (such as the tools 42 of the above-described embodiment) used in the division task are stored, respectively.

With the above configuration (9), the work support information includes the route for collecting the tool required in the division task. If the plurality of tools are respectively stored in the plurality of storage shelves, for example, by providing the shortest route passing through the plurality of storage shelves as the work support information, the worker can collect the tool by the most efficient route.

(10) A work support method according to an embodiment of the present disclosure is a work support method that gives work support by using a work schedule (such as the work schedule WS of the above-described embodiment) which is created by dividing at least one support target work into a plurality of division tasks (such as the division tasks T1, T2, . . . of the above-described embodiment) with a unit work amount corresponding to a worker unit (such as the worker units A to E of the above-described embodiment) including a plurality of workers, and distributing the worker unit to each of the plurality of division tasks, the work support method including a step (such as step S100 of the above-described embodiment) of acquiring, by an interruption information acquisition part (such as the interruption information acquisition part 18 of the above-described embodiment), interruption information indicating that an interruption event (such as the interruption event Y of the above-described embodiment) occurs in any of the plurality of division tasks, and a step (such as step S102 of the above-described embodiment) of modifying, by a work schedule modification part (such as the work schedule modification part 14 of the above-described embodiment), the work schedule by redistributing, to the division task started after the interruption event, the remaining worker unit excluding the worker unit distributed to the division task in which the interruption event occurs, if the interruption information acquisition part acquires the interruption information.

With the above method (10), the work schedule is created by dividing the support target work into the plurality of division tasks having the unit work amount and distributing the worker unit to each of the plurality of division tasks. In such work schedule, if the interruption event occurs in any of the division tasks, the work schedule is modified by redistributing, to the division task started after the interruption event, the remaining worker unit excluding the worker unit distributed to the division task in which the interruption event occurs. Thus, even if the interruption event occurs in some of the division tasks, it is possible to construct the work schedule that efficiently utilizes the worker unit distributed to another division task.

(11) A work support program according to an embodiment of the present disclosure causes, in order to give work support by using a work schedule (such as the work schedule WS of the above-described embodiment) which is created by dividing at least one support target work into a plurality of division tasks (such as the division tasks T1, T2, . . . of the above-described embodiment) with a unit work amount corresponding to a worker unit (such as the worker units A to E of the above-described embodiment) including a plurality of workers, and distributing the worker unit to each of the plurality of division tasks, a computer to function as a means (such as the interruption information acquisition part 18 of the above-described embodiment) for acquiring interruption information indicating that an interruption event occurs in any of the plurality of division tasks, and a means (such as the work schedule modification part 14 of the above-described embodiment) for modifying the work schedule by redistributing, to the division task started after the interruption event, the remaining worker unit excluding the worker unit distributed to the division task in which the interruption event occurs, if the interruption information is acquired.

With the above program (11), the work schedule is created by dividing the support target work into the plurality of division tasks having the unit work amount and distributing the worker unit to each of the plurality of division tasks. In such work schedule, if the interruption event occurs in any of the division tasks, the work schedule is modified by redistributing, to the division task started after the interruption event, the remaining worker unit excluding the worker unit distributed to the division task in which the interruption event occurs. Thus, even if the interruption event occurs in some of the division tasks, it is possible to construct the work schedule that efficiently utilizes the worker unit distributed to another division task.

### REFERENCE SIGNS LIST

1 Work support system
2 Communication network
4 Main server
6 Data server
6a Worker unit database
6b Division task database
6c Work schedule database
8 Input terminal
10a, 10b User terminal
12 Work schedule creation part
14 Work schedule modification part
16 Division task completion information acquisition part
18 Interruption information acquisition part
20 Work support information creation part
22 Worker identification information acquisition part
24 Output part
30 Pipe
32, 34 Pipe member
36 Orifice
40 Storage shelf
40a Shelf
42 Tool
44 Barcode tag
C1 First critical path
C2 Second critical path
F Foreman
H Helper

1. A work support system that gives work support by using a work schedule which is created by dividing at least one support target work into a plurality of division tasks with a unit work amount corresponding to a worker unit including a plurality of workers, and distributing the worker unit to each of the plurality of division tasks, the work support system comprising:
an interruption information acquisition part configured to acquire interruption information indicating that an interruption event occurs in any of the plurality of division tasks; and
a work schedule modification part configured to modify the work schedule by redistributing, to the division task started after the interruption event, the remaining worker unit excluding the worker unit distributed to the division task in which the interruption event occurs, if the interruption information acquisition part acquires the interruption information.

2. The support work system according to claim 1,
wherein the work schedule modification part modifies the work schedule to distribute the worker unit, which is distributed to the division task included in a critical path to which the division task where the interruption event occurs belongs and started after the interruption event, to the division task which is included in a critical path different from the critical path of the division task where the interruption event occurs and is started after the interruption event.

3. The support work system according to claim 1, further comprising a division task completion information acquisition part for acquiring division task completion information indicating that any of the plurality of division tasks is completed,
wherein the work schedule modification part is configured to modify the work schedule by redistributing the worker unit to the remaining division task, if the division task completion information acquisition part acquires the division task completion information.

4. The support work system according to claim 1,
wherein the at least one support target work includes a plurality of support target works independent of each other, and
wherein the work schedule modification part is configured to modify a plurality of work schedules corresponding to the plurality of support target works, respectively.

5. The support work system according to claim 1, further comprising an output part configured to output work support information about the division task based on the work schedule.

6. The support work system according to claim 5,
wherein the work support information includes information about at least one of a tool used in the division task, the worker unit, and a work caution.

7. The support work system according to claim 6,
wherein the division task includes installation work for an orifice which is disposed between a pair of pipe members in correspondence with a direction of a fluid flowing inside the pair of pipe members, and
wherein the work caution includes information about an installation direction of the orifice.

8. The support work system according to claim 5, further comprising a worker identification information acquisition part configured to acquire worker identification information for identifying the worker,
wherein the output part is configured to output the work support information, if the worker identification information acquisition part acquires the worker identification information, which corresponds to the work support information, corresponding to the worker unit.

9. The support work system according to claim 6,
wherein the information about the used tool includes information about a shortest route passing through a plurality of storage shelves in which a plurality of tools used in the division task are stored, respectively.

10. A work support method that gives work support by using a work schedule which is created by dividing at least one support target work into a plurality of division tasks with a unit work amount corresponding to a worker unit including a plurality of workers, and distributing the worker unit to each of the plurality of division tasks, the work support method comprising:
a step of acquiring, by an interruption information acquisition part, interruption information indicating that an interruption event occurs in any of the plurality of division tasks; and
a step of modifying, by a work schedule modification part, the work schedule by redistributing, to the division task started after the interruption event, the remaining worker unit excluding the worker unit distributed to the division task in which the interruption event occurs, if the interruption information acquisition part acquires the interruption information.

11. A work support program for causing, in order to give work support by using a work schedule which is created by dividing at least one support target work into a plurality of division tasks with a unit work amount corresponding to a worker unit including a plurality of workers, and distributing the worker unit to each of the plurality of division tasks, a computer to function as:
a means for acquiring interruption information indicating that an interruption event occurs in any of the plurality of division tasks; and
a means for modifying the work schedule by redistributing, to the division task started after the interruption event, the remaining worker unit excluding the worker unit distributed to the division task in which the interruption event occurs, if the interruption information is acquired.
